(19) United States
(12) Patent Application Publication
(10) Pub. No.: US 2020/0039121 A1
(43) Pub. Date: Feb. 6, 2020

(54) ULTRAFILTRATION MEMBRANE AND ITS PREPARATION METHOD

(71) Applicant: Shanghai Jishuai Bio Technology CO., LTD, Shanghai (CN)

(72) Inventor: Li Shengmin, Shanghai (CN)

(21) Appl. No.: 16/053,612

(22) Filed: Aug. 2, 2018

(51) Int. Cl. B29C 41/00; B29C 41/46; B01D 61/14; B01D 69/02; B01D 67/00

(52) U.S. Cl. CPC B29C 41/003; B29C 41/46; B01D 61/145; B29K 2079/085; B01D 67/0079; B01D 67/0095; B01D 69/02

(57) ABSTRACT

The present invention relates to a method for preparing an ultrafiltration membrane with high mechanical property. In the present invention, since the cellulose, which has high mechanical property, is added into the casting membrane solution, the retention rate of the ultrafiltration membrane of the present invention is improved.

### TECHNICAL FIELD

The present invention relates to an ultrafiltration membrane with high mechanical property and its preparation method.

### BACKGROUND

At present, due to the fact that the ultrafiltration membrane is pressed for a long time but has poor mechanical property, the ultrafiltration membrane's service life is shortened, and the ultrafiltration membrane in the membrane module needs to be frequently replaced.

Therefore, it is necessary to develop an ultrafiltration membrane capable of improving the mechanical property of the ultrafiltration membrane.

### SUMMARY OF THE INVENTION

An objective of the present invention is to provide an ultrafiltration membrane with high mechanical property and its preparation method.

The present invention relates to a method for preparing an ultrafiltration membrane with high mechanical property. In the present invention, since the cellulose, which has high mechanical property, is added into the casting membrane solution, the retention rate of the ultrafiltration membrane of the present invention is improved.

### DETAILED DESCRIPTION OF THE EMBODIMENTS

### Example 1

Step 1: Polyetherimide 16 g, cellulose 8 g and lithium chloride 0.8 g are added into a 3-neck flask;

Step 2: then N,N-dimethylacetamide 50 g is added into the 3-neck flask to obtain a mixture, the mixture is stirred at 65° C. for 5 h;

Step 3: standing for defoaming in an environment with a temperature of 20° C. and a humidity of 20% for 8 h to obtain a uniform foam-free casting membrane solution;

Step 4: the casting membrane solution is poured on a glass substrate, and the casting membrane solution on the glass substrate is applied by a membrane applicator to obtain a liquid-state membrane with a thickness of 200 μm;

Step 5: the glass substrate with the liquid-state membrane formed thereon is placed in an environment with a temperature of 20° C. and humidity of 20% for volatilizing for 15 s;

Step 6: the glass substrate with the liquid-state membrane formed thereon is placed in deionized water, to solidify the liquid-state membrane into a solid-state membrane; and

Step 7: the solid-state membrane is taken out of the deionized water, air-dried and placed in a drying oven for 10 min, to obtain the ultrafiltration membrane.

For reference example, all of the experimental conditions are the same as those of embodiment 1, except that the cellulose is not added.

TABLE 1

| | | | | | | | | | | Example | |
|---|---|---|---|---|---|---|---|---|---|---|---|
| Items | Example 1 | Example 2 | Example 3 | Example 4 | Example 5 | Example 6 | Example 7 | Example 8 | Example 9 | 10 | Reference |
| The mass | 32 | 20 | 50 | 32 | 32 | 32 | 32 | 32 | 32 | 32 | 32 |
| concentration | | | | | | | | | | | |
| of | | | | | | | | | | | |
| Polyetherimide | | | | | | | | | | | |
| (%) | | | | | | | | | | | |
| The mass | 0.5:1 | 0.5:1 | 0.5:1 | 0.1:1 | 1:1 | 0.5:1 | 0.5:1 | 0.5:1 | 0.5:1 | 0.5:1 | — |
| ratio of | | | | | | | | | | | |
| cellulose | | | | | | | | | | | |
| and | | | | | | | | | | | |
| Polyetherimide | | | | | | | | | | | |
| The mass | 0.05:1 | 0.05:1 | 0.05:1 | 0.05:1 | 0.05:1 | 0.01:1 | 0.1:1 | 0.05:1 | 0.05:1 | 0.05:1 | 0.05:1 |
| ratio of | | | | | | | | | | | |
| LITHIUM | | | | | | | | | | | |
| CHLORIDE | | | | | | | | | | | |
| and | | | | | | | | | | | |
| Polyetherimide | | | | | | | | | | | |
| The first | 65 | 65 | 65 | 65 | 65 | 65 | 65 | 65 | 50 | 90 | 65 |
| temperature | | | | | | | | | | | |
| (° C.) | | | | | | | | | | | |
| The second | 20 | 20 | 20 | 20 | 20 | 20 | 20 | 15 | 20 | 20 | 20 |
| temperature | | | | | | | | | | | |
| (° C.) | | | | | | | | | | | |
| The third | 20 | 20 | 20 | 20 | 20 | 20 | 20 | 25 | 20 | 20 | 20 |
| temperature | | | | | | | | | | | |
| (° C.) | | | | | | | | | | | |
| The first | 20 | 20 | 20 | 20 | 20 | 20 | 20 | 10 | 20 | 20 | 20 |
| humidity | | | | | | | | | | | |
| (%) | | | | | | | | | | | |
| The second | 20 | 20 | 20 | 20 | 20 | 20 | 20 | 30 | 20 | 20 | 20 |
| humidity | | | | | | | | | | | |
| (%) | | | | | | | | | | | |
| The first | 8 | 8 | 8 | 8 | 8 | 8 | 8 | 8 | 10 | 6 | 8 |
| period (h) | | | | | | | | | | | |
| The second | 15 | 15 | 15 | 15 | 15 | 15 | 15 | 15 | 10 | 120 | 15 |
| period (s) | | | | | | | | | | | |
| The third | 10 | 10 | 10 | 10 | 10 | 10 | 10 | 10 | 5 | 60 | 10 |
| period | | | | | | | | | | | |
| (min) | | | | | | | | | | | |

In examples 1-3, all of the experimental conditions are the same except that the mass concentrations of Polyetherimide are 32%, 20% and 50%, respectively.

In examples 1, 4 and 5, all of the experimental conditions are the same except that the mass ratios between cellulose and Polyetherimide are 0.5:1, 0.1:1 and 1:1, respectively.

In examples 1, 6 and 7, all of the experimental conditions are the same except that the mass ratios between LITHIUM CHLORIDE and Polyetherimide are 0.05:1, 0.01:1 and 0.1:1, respectively.

In examples 1 and 8, all of the experimental conditions are the same except that: in example 1, the second and third temperature, the first and second humidity are 20° C., 20° C., 20% and 20%, respectively; but in example 8, they are 15° C., 25° C., 10% and 30%, respectively. That is, the environments for defoaming and for forming the solid-state membrane are different.

In examples 1, 9 and 10, all of the experimental conditions are the same except that the first temperature, the first, second and third period of them are different, that is, the temperature for preparing the casting membrane solution, the period for preparing the casting membrane solution, the period for volatilizing the applied liquid membrane and the period for drying the membrane sample are different.

### Test Example 1

The mechanical properties of the membranes prepared in examples 1-10 and the comparative example are measured and compared, the measurement results are shown in Table 2.

Mechanical Property Test:

Test instrument: Paper and paper board tensile tester ZL-100A

Test Steps:

Firstly, a to-be-tested membrane sample is cut into a shape adapted to the tester and a scale distance is marked with two marking lines;

Secondly, the cut membrane sample is placed in the holder of the tester, and is carefully adjusted to a symmetric position to allow the stretching force to be uniformly distributed on the cross section of the membrane sample;

Finally, the tester is started, and the maximum force (with the error of ±1%) at which the membrane sample is broken and the distance (with the error of ±1.25 mm) between the inner sides of the two marking lines are recorded.

The mechanical property can be calculated as below:

$$P ( MPa ) = \frac{F}{A} \qquad ( Equation 1 )$$

wherein, P is average tensile strength, F is maximum force at break, and A is average initial cross section area,

$$α ( \% ) = \frac{L - {L}_{0}}{{L}_{0}} \times 100 \qquad ( Equation 2 )$$

wherein, α is elongation at break, L is scale distance at break, and L₀ is initial scale distance.

### Test Example 2

Measurements of the water fluxes and methylene blue retention rates

Test pressure: 0.1 Mpa

Test Steps:

Firstly, the membrane sample is mounted in the membrane property tester;

Secondly, the deionized water is filled into the membrane pool of the membrane property tester;

Finally, the membrane pool is pressurized to allow the deionized water in the membrane pool to pass through the membrane and flow out of the outlet end, so as to calculate the water flux of the membrane sample.

The computational formula of the flux:

$$B ( L \cdot {m}^{- 2} \cdot {h}^{- 1} ) = \frac{V}{D \cdot t} \qquad ( Equation 3 )$$

wherein, B is water flux of the membrane sample with the unit of (L·m⁻²·h⁻¹), V is the total volume of the water flowing out of the outlet end of the membrane property tester, D is the area of the membrane sample, and t is total test time.

Retention Rate Test:

Test instrument: ultrafiltration cup, ultraviolet-visible spectrophotometer

Test pressure: 1 Mpa

Test Steps:

First, the membrane sample is mounted in the ultrafiltration cup.

Second, 1 g/L methylene blue aqueous solution is filled into the membrane pool of the ultrafiltration cup.

Thirdly, the membrane pool is pressurized to allow the methylene blue aqueous solution in the membrane pool to pass through the membrane, wherein at least a part of the methylene blue is retained on the membrane, and the rest of the methylene blue aqueous solution flows out of the outlet end.

Finally, the methylene blue concentrations of the methylene blue aqueous solution in the membrane pool and the methylene blue aqueous solution flowing out of the outlet end are detected by the ultraviolet spectrophotometer, to calculate the methylene blue retention rate of the membrane sample.

The computational formula of the retention rate:

$$R ( \% ) = \frac{c}{{c}_{0}} \times 100 \qquad ( Equation 4 )$$

wherein, R is the methylene blue retention rate of the membrane sample, c is the methylene blue concentration of the methylene blue aqueous solution flowing out of the outlet end, and c₀ is the methylene blue concentration of the methylene blue aqueous solution in the membrane pool.

TABLE 2

| | Average tensile | Elongation | Water flux | Methylene |
|---|---|---|---|---|
| | strength (Mpa) | at | (L · m⁻² · | blue retention |
| Example | (23° C.) | break (%) | MPa⁻¹ · h⁻¹) | rate (%) |
| Example 1 | 150.9 | 100 | 139.2 | 56 |
| Example 2 | 101.1 | 60 | 144.5 | 19 |
| Example 3 | 129.3 | 76 | 100.7 | 47 |
| Example 4 | 104.1 | 58 | 135.5 | 39 |
| Example 5 | 136.9 | 90 | 99.7 | 49 |
| Example 6 | 149.5 | 93 | 94.8 | 41 |
| Example 7 | 143.2 | 80 | 112.4 | 38 |
| Example 8 | 141.1 | 93 | 130.2 | 52 |
| Example 9 | 132.1 | 86 | 128.9 | 36 |
| Example 10 | 134.5 | 87 | 105.9 | 62 |
| reference | 89.7 | 55 | 103.6 | 34 |

It can be seen in the Table 2 that, the examples 1-10 have an average tensile strength and elongation at break higher than those of the reference example, indicating that the addition of cellulose can improve the mechanical property of the membrane.

In addition, the comparative results obtained by comparing the water fluxes and methylene blue retention rates between examples 1-10 and reference example indicate that: with the addition of an appropriate amount of cellulose in the casting membrane solution of the present invention, the retention rate of the ultrafiltration membrane of the present invention is improved under the circumstance that the flux is kept constant.

In combination with Tables 1 and 2, the following conclusion is obtained:

In examples 1-3, the mass concentrations of the Polyetherimide are 32%, 20% [symbol] 150%, respectively, while the other experimental conditions are same. It can be seen that the example 1 has the average tensile strength, the elongation at break, the water flux and the methylene blue retention rate better than those of examples 2 and 3, indicating that the preferable mass concentration of Polyetherimide is 32%.

In examples 1, 4 and 5, it can be seen that example 1 has the average tensile strength, the elongation at break, the water flux and the methylene blue retention rate better than those of example 4 and example 5, indicating that the preferable mass ratio of cellulose and Polyetherimide is 0.5:1.

In examples 1, 6 and 7, it can be seen that example 1 has the average tensile strength, the elongation at break, the water flux and the methylene blue retention rate better than those of examples 6 and 7, indicating that the preferable mass ratio of LITHIUM CHLORIDE and Polyetherimide is 0.05:1.

Comparing examples 1 and 8, it can be seen that example 1 has the average tensile strength, the elongation at break, the water flux and the methylene blue retention rate better than those of example 8, indicating that the second temperature, the third temperature, the first humidity and the second humidity are preferably 20° C., 20° C., 20% and 20%, respectively.

Comparing examples 1, 9 and 10, it can be seen that example 1 has the average tensile strength, the elongation at break, the water flux and the methylene blue retention rate better than those of examples 9-10, indicating that the first temperature, the first period, the second period and the third period are preferably 65° C., 8 h, 15 s and 10 min, respectively.

In conclusion, compared with the reference example, the examples 1-10 are preferable; the example 1, example 4, example 7 and example 8 are more preferable; and the example 1 is the most preferable.

1. A method for preparing an ultrafiltration membrane, comprising the following steps:
dissolving Polyetherimide, cellulose and lithium chloride in N,N-dimethylacetamide at a first temperature to form an initial casting membrane solution, and standing for defoaming at a second temperature and a first humidity for a first period to obtain a treated casting membrane solution;
pouring the treated casting membrane solution on a glass substrate, and obtaining a liquid-state membrane with a thickness of 150-250 μm by using a membrane applicator;
allowing the liquid-state membrane to volatilize at a third temperature and a second humidity for a second period, and placing the glass substrate together with the liquid-state membrane formed thereon in a coagulation bath, to allow the liquid-state membrane to solidify to obtain a solid-state membrane; and
taking the solid-state membrane out of the coagulation bath, air-drying, and drying it in a drying oven for a third period, to obtain the ultrafiltration membrane.

2. The method according to claim 1, wherein,
the first temperature is 50-90 □;
the second temperature is 15-25 □;
the third temperature is 15-25 □;
the first humidity is 10%-30%;
the second humidity is 10%-30%;
the first period is 6-10 hours;
the second period is 10-120 seconds; and
the third period is 60 minutes.

3. The method according to claim 1, wherein, in the treated casting membrane solution,
the mass concentration of the Polyetherimide is 20%-40%,
the mass ratio between the cellulose and the Polyetherimide is 0.1-1:1, and
the mass ratio between the lithium chloride and the Polyetherimide is 0.01-0.1:1.

4. The method according to claim 1, wherein, in the third step, the coagulation bath is deionized water.

5. Ultrafiltration membrane prepared according to claim 1.
